(19) United States
(12) Patent Application Publication
(10) Pub. No.: US 2023/0182970 A1
(43) Pub. Date: Jun. 15, 2023

(54) MULTI-LID HEAT-INSULATING CUP

(71) Applicant: Hangzhou Lezhou Technology Co.,Ltd., Hangzhou City (CN)

(72) Inventor: Lingyu Yang, Hangzhou (CN)

(21) Appl. No.: 17/684,435

(22) Filed: Mar. 2, 2022

(30) Foreign Application Priority Data
Dec. 13, 2021 (CN) 202123127281.1

(51) Int. Cl. B65D 43/16; A47G 19/22; B65D 47/08; B65D 47/12; B65D 51/16; B65D 81/38

(52) U.S. Cl. CPC B65D 43/161; A47G 19/2288; B65D 47/0857; B65D 47/123; B65D 51/1683; B65D 81/3874; B65D 2205/02; B65D 2543/00046

(57) ABSTRACT

A multi-lid heat-insulating cup is provided, including a heat-insulating cup body with an accommodating cavity and a cup lid detachably connected to the heat-insulating cup body, the cup lid being provided with a drinking mouthpiece and a drinking mouthpiece lid being disposed at the drinking mouthpiece, where an inner top surface of the cup lid is provided with a ring-shaped sealing gasket; and with the cup lid covering an opening end of the heat-insulating cup body, the sealing gasket is capable of sealing both the opening end of the heat-insulating cup body and a top periphery of a pop can placed in the accommodating cavity, and a beverage outlet of the pop can is in communication with the drinking mouthpiece. The cup lid which can cover an opening of the heat-insulating cup body is disposed to increase a heat insulation effect.

### TECHNICAL FIELD

The present invention relates to a heat-insulating cup, in particular to a multi-lid heat-insulating cup which can conveniently perform heat insulation for a pop can or beer bottle.

### BACKGROUND

Traditional heat-insulating cups are only used for drinking tea and water. In many occasions, such as drinking while working, or needing to slowly sip canned or bottled iced beverage (such as cola and beer) in a leisure environment, as time passes by, temperature of the beverage will quickly increase due to ambient temperature, and the mouthfeel of the beverage will soon become compromised. Moreover, condensed water formed on a can or bottle body flows down along the body, and contaminates documents and devices. In addition, such traditional heat-insulating cups are prone to shake and cause the beverage to splash out when fixing a canned or bottled beverage.

In view of the aforementioned current situation, some people invented, for example, a “Dual-purpose Heat-Insulating Cup” under the CN utility model patent number ZL202021395246.0 (publication number CN212939250U), which discloses a heat-insulating cup, including a cup body and a fixing ring fixed at an opening of the cup body, where the cup body is a vacuum cup body, the inner wall of the cup body is stepped, and the inner wall of the opening of the cup body is provided with an internal thread. Since the vacuum cup body is adopted, and the inner wall of the cup body is stepped, the diameter of an upper section of an inner space of the cup body is greater than that of a lower section, so that a heat insulation effect of the heat-insulating cup can be ensured, and the heat-insulating cup can adapt to pop cans of different sizes; when the fixing ring sleeves the opening of the cup body, heat insulation can be performed on the canned or bottled beverage, if the fixing ring replaced with a cup lid mating with the internal thread at the opening of the cup body, the heat-insulating cup can be directly used for drinking tea or water, so that the heat-insulating cup has a wider range of applications; the fixing ring is made of elastic silica gel, the fixing ring is provided with a fastening ring around the center of the circle, and the inner wall is provided with anti-slip patterns, which can fix the pop can so that the pop can will not shake easily.

However, when the pop can is placed in the aforementioned heat-insulating cup, a top end of the pop can is completely exposed, which affects the heat insulation effect for the pop can. Moreover, after the pop can is opened, the beverage will lose its fizz and go flat fast as a drinking port is exposed all the time.

### SUMMARY

The technical problem to be solved by the present invention is to provide, in view of the current situation of the prior art, a multi-lid heat-insulating cup which is rational in structural design and convenient for performing heat insulation on a pop can, and the heat-insulating cup can enclose the pop can for heat insulation and can also serve as a conventional heat-insulating cup.

The technical scheme adopted by the present invention to solve the above technical problems is: a multi-lid heat-insulating cup, including a heat-insulating cup body with an accommodating cavity and a cup lid detachably connected to the heat-insulating cup body, the cup lid being provided with a drinking mouthpiece and a drinking mouthpiece lid being disposed at the drinking mouthpiece, where an inner top surface of the cup lid is provided with a ring-shaped sealing gasket; and with the cup lid covering an opening end of the heat-insulating cup body, the sealing gasket is capable of sealing both the opening end of the heat-insulating cup body and a top periphery of a pop can placed in the accommodating cavity, and a beverage outlet of the pop can is in communication with the drinking mouthpiece.

Further, as an improvement, an inner wall of the heat-insulating cup body is provided with one or more step portions, such that a diameter of an upper section of the accommodating cavity is greater than that of a lower section. This structure can accommodate pop cans of different sizes.

Optionally, the drinking mouthpiece is configured to protrude upwards, the drinking mouthpiece lid is attached to the drinking mouthpiece by a threaded or snap-fit connection, and an inner end surface of the drinking mouthpiece lid is provided with a sealing ring which forms sealing with an opening end of the drinking mouthpiece. The drinking mouthpiece is configured to protrude upward, which is convenient for users to drink, and the sealing ring is disposed to better prevent liquid leakage from the drinking mouthpiece.

Optionally, a connecting sheet is hinged to a top portion of the cup lid, the connecting sheet is provided with a mounting hole, and the drinking mouthpiece lid is constrained within the mounting hole and capable of rotating around its own axis. The connecting sheet connects the drinking mouthpiece lid and the cup lid together to prevent the drinking mouthpiece lid from being lost.

Still further, as an improvement, the cup lid includes an outer lid and a top lid, the outer lid being ring-shaped; the outer lid is attached to the heat-insulating cup body by a threaded or snap-fit connection; a top portion of an inner peripheral wall of the outer lid is provided with an inwardly extending stop ring; the top lid is detachably nested into the stop ring, a bottom surface of the top lid has a downwardly extending ring-shaped wall, a nesting groove in which the sealing gasket is to be nested is formed between an outer periphery of the ring-shaped wall and the inner peripheral wall of the outer lid, and the drinking mouthpiece is disposed on the top lid and is in communication with a space defined by the ring-shaped wall. With this structure, the top lid part can be detached from the outer lid, after the top lid is detached, the existing heat-insulating cup structure for the pop can is realized, the top end is open and enables placement of a beer bottle, and the beer bottle can penetrate the outer lid upwards.

Further, as an improvement, an outer periphery of the top lid and an inner wall of the stop ring are detachably attached to each other by a snap-fit connection through a rib-groove configuration. A snap-fit constraint is formed between the top lid and the inner wall of the stop ring, such that a considerable force has to be exerted to detach the top lid from the outer lid, that is, the top lid is prevented from being easily detached from the outer lid.

As an improvement, a bottom portion of the outer periphery of the ring-shaped wall is provided with an outwardly extending stop, and the stop forms a position limitation on a bottom surface of the sealing gasket. The stop is configured to further limit the sealing gasket, such that the combination of the sealing gasket and the cup lid is more robust.

In order to further firmly combine the sealing gasket with the cup lid, a top surface of the sealing gasket is provided with a plurality of upwardly extending elastic catches, the top lid is provided with recesses, and the elastic catches are snap-fitted in the recesses.

Further, as an improvement, a top surface of the outer lid is fixedly provided with a ring-shaped limiting member made of a flexible material, and an inner edge of the limiting member protrudes radially inward from a peripheral wall of the stop ring. The limiting member plays a role in retaining and decorating the top lid, and more importantly, when the top lid is detached, the inner edge of the limiting member makes frictional contact with the peripheral wall of the beer bottle penetrating the outer lid, thereby retaining the beer bottle.

Optionally, the limiting member is integrally formed with the outer lid. Of course, ultrasonic welding can also be used.

Compared with the prior art, the present invention has the advantages: on the basis of the existing heat-insulating cup body, the cup lid which can cover an opening of the heat-insulating cup body is disposed to increase a heat insulation effect, and the sealing gasket is disposed to form sealing with the top periphery of the pop can placed in the accommodating cavity, so that the beverage flowing out from a drinking mouthpiece of the pop can is prevented from flowing into the heat-insulating cup body, and a beverage outlet of the pop can is in communication with the drinking mouthpiece, without affecting drinking of the beverage.

### BRIEF DESCRIPTION OF DRAWINGS

FIG. 1 is a three-dimensional schematic diagram of an embodiment of the present invention;

FIG. 2 is a cross-sectional view of an embodiment of the present invention;

FIG. 3 is an exploded view of an embodiment of the present invention;

FIG. 4 is a cross-sectional view of performing heat insulation on a pop can of a certain size according to an embodiment of the present invention;

FIG. 5 is a cross-sectional view of performing heat insulation on a pop can of another size according to an embodiment of the present invention;

FIG. 6 is a three-dimensional schematic diagram of an embodiment of the present invention with a top lid removed;

FIG. 7 is a three-dimensional schematic diagram of performing heat insulation on a beer bottle according to an embodiment of the present invention; and

FIG. 8 is a cross-sectional view of performing heat insulation on a beer bottle according to an embodiment of the present invention.

### DETAILED DESCRIPTION

The present invention will be further described in detail with reference to the accompanying drawings and embodiment.

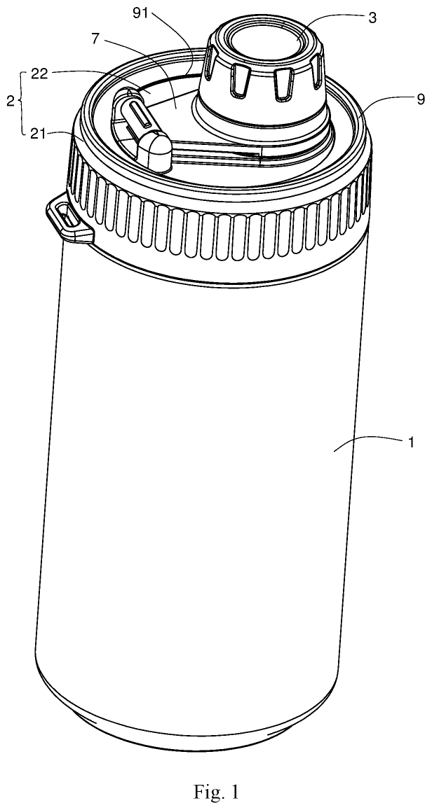

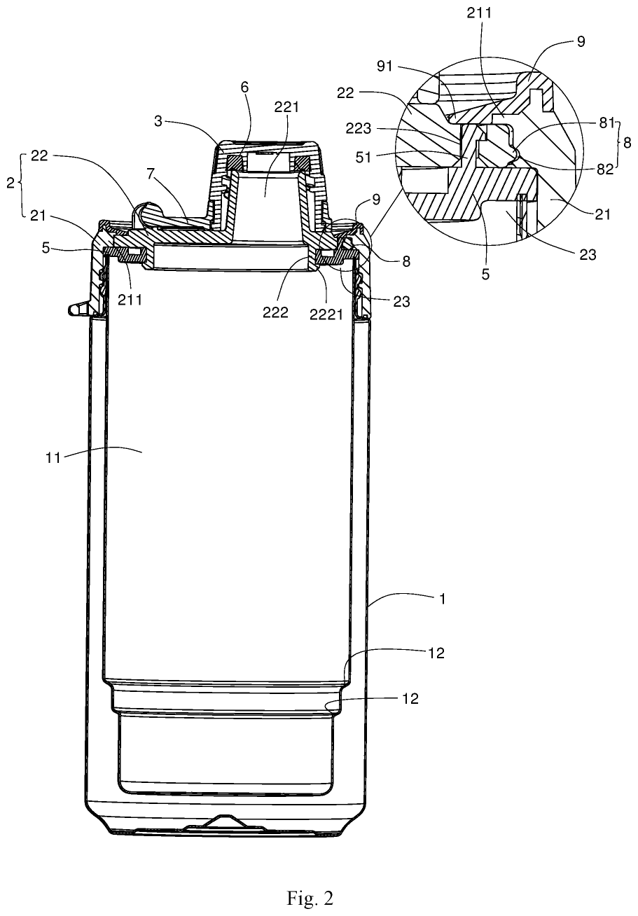

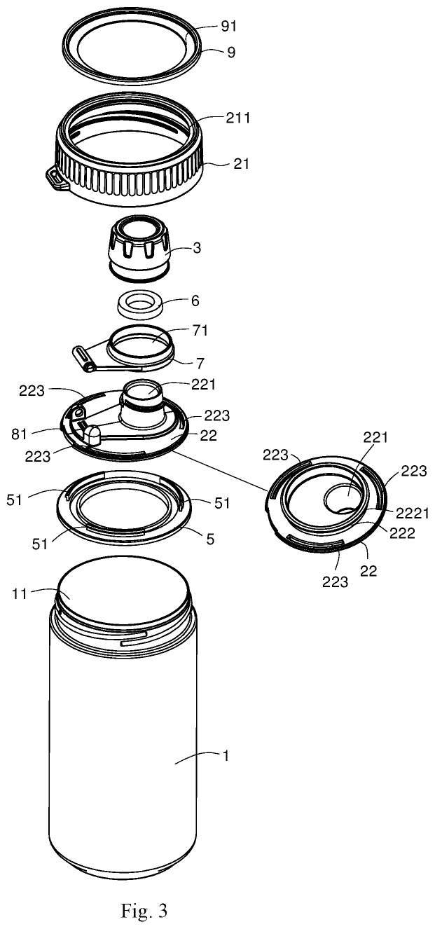

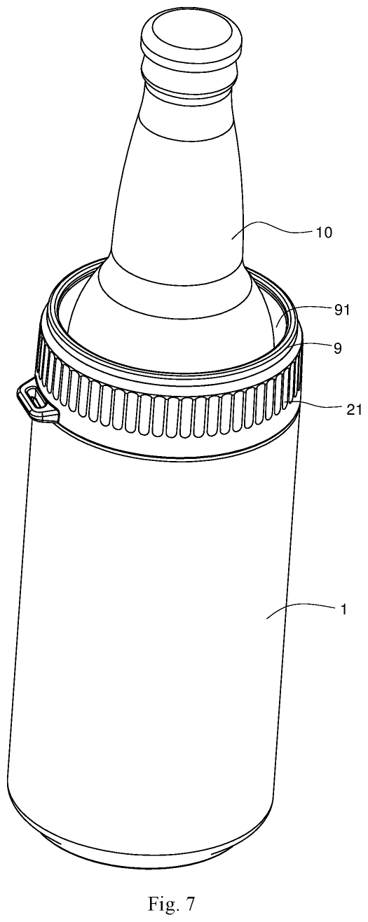

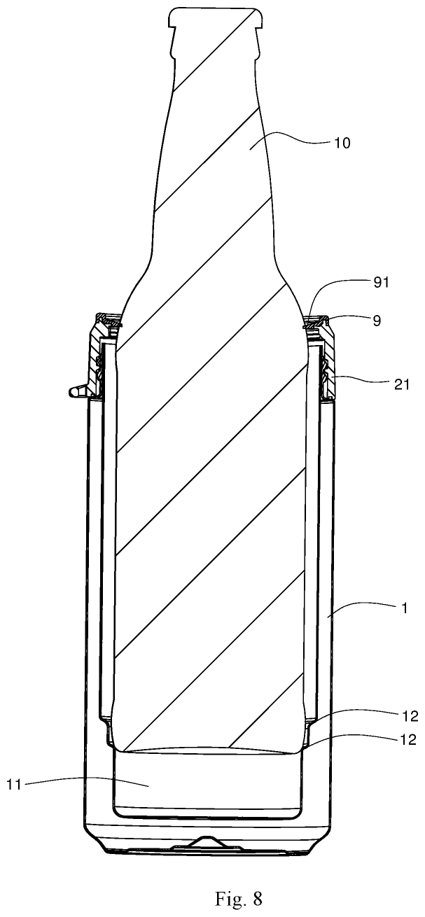

As shown in FIGS. 1-8, provided is a preferred embodiment of the present invention.

A multi-lid heat-insulating cup includes a heat-insulating cup body 1 with an accommodating cavity 11 and a cup lid 2 detachably connected to the heat-insulating cup body 1. The heat-insulating cup body 1 is of a double-layer structure. An inner wall of the heat-insulating cup body 1 is provided with one or more step portions 12, such that a diameter of an upper section of the accommodating cavity 11 is greater than that of a lower section. The cup lid 2 is provided with a drinking mouthpiece 221, and the drinking mouthpiece 221 is provided with a drinking mouthpiece lid 3.

An inner top surface of the cup lid 2 is provided with a ring-shaped sealing gasket 5. The sealing gasket 5 is a thin piece made of a flexible material. With the cup lid 2 covering an opening end of the heat-insulating cup body 1, the sealing gasket 5 is capable of sealing both the opening end of the heat-insulating cup body 1 and a top periphery of a pop can 4 placed in the accommodating cavity 11, and a beverage outlet of the pop can 4 is in communication with the drinking mouthpiece 221.

The drinking mouthpiece 221 is configured to protrude upwards, the drinking mouthpiece lid 3 is attached to the drinking mouthpiece 221 by a threaded or snap-fit connection, and an inner end surface of the drinking mouthpiece lid 3 is provided with a sealing ring 6 which forms sealing with an opening end of the drinking mouthpiece 221. A connecting sheet 7 is hinged to a top portion of the cup lid 2, the connecting sheet 7 is provided with a mounting hole 71, and the drinking mouthpiece lid 3 is constrained within the mounting hole 71 and capable of rotating around its own axis.

As a significant improvement, the cup lid 2 includes an outer lid 21 and a top lid 22, the outer lid 21 being ring-shaped; the outer lid 21 is attached to the heat-insulating cup body 1 by a threaded or snap-fit connection; a top portion of an inner peripheral wall of the outer lid 21 is provided with an inwardly extending stop ring 211; the top lid 22 is detachably nested into the stop ring 211, a bottom surface of the top lid 22 has a downwardly extending ring-shaped wall 222, a nesting groove 23 in which the sealing gasket 5 is to be nested is formed between an outer periphery of the ring-shaped wall 222 and the inner peripheral wall of the outer lid 21, and the drinking mouthpiece is disposed on the top lid 22 and is in communication with a space defined by the ring-shaped wall 222.

An outer periphery of the top lid 22 and an inner wall of the stop ring 211 are detachably attached to each other by a snap-fit connection through a rib-groove configuration 8. A convex rib 81 of the rib-groove configuration 8 is disposed on the outer peripheral wall of the top lid 22, and a groove 82 of the rib-groove configuration 8 is disposed on the inner peripheral wall of the stop ring 211. A bottom portion of the outer periphery of the ring-shaped wall 222 is provided with an outwardly extending stop 2221, and the stop 2221 forms a position limitation on a bottom surface of the sealing gasket 5.

A top surface of the sealing gasket 5 is provided with a plurality of upwardly extending elastic catches 51, the top lid 22 is provided with recesses 223, and the elastic catches 51 are snap-fitted in the recesses 223.

A top surface of the outer lid 21 is fixedly provided with a ring-shaped limiting member 9 made of a flexible material, and an inner edge 91 of the limiting member 9 protrudes radially inward from a peripheral wall of the stop ring 211. The limiting member 9 is integrally formed with the outer lid 21.

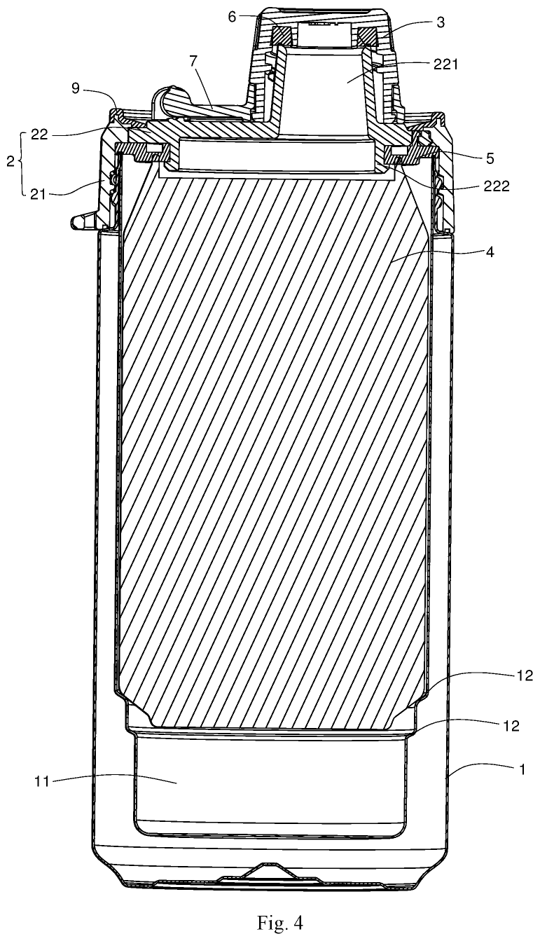

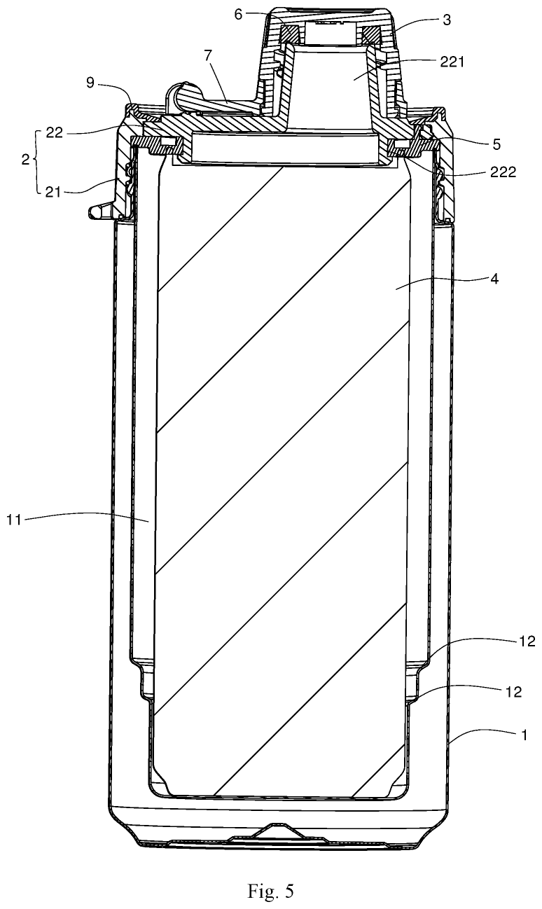

As shown in FIGS. 4 and 5, on the basis of the existing heat-insulating cup body 1, the cup lid 2 which can cover an opening of the heat-insulating cup body 1 is disposed to increase a heat insulation effect, and the sealing gasket 5 is disposed to form sealing with the top periphery of the pop can 4 placed in the accommodating cavity 11, so that the beverage flowing out from a drinking mouthpiece of the pop can 4 is prevented from flowing into the heat-insulating cup body 1, and a beverage outlet of the pop can 4 is in communication with the drinking mouthpiece 221, without affecting drinking of the beverage.

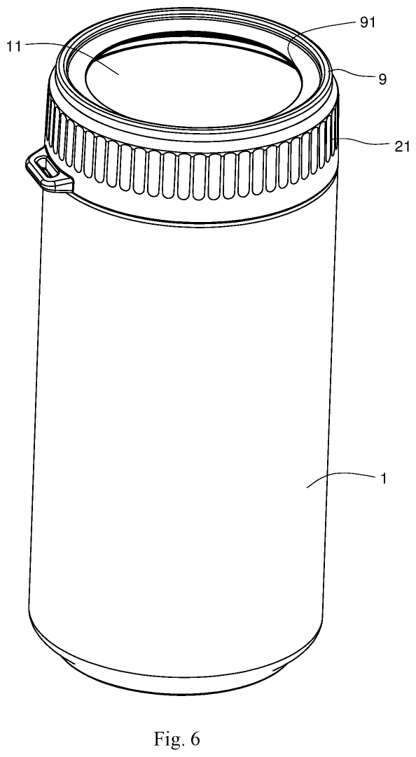

As shown in FIGS. 6-8, if a beer bottle 10 needs heat insulation, the sealing gasket 5 is detached from the outer lid 21 together with the top lid 22, and then the outer lid 21 is screwed onto to the heat-insulating cup body 1, so that the beer bottle 10 penetrates the outer lid upwards, and the inner edge 91 of the limiting member 9 is in frictional contact with a body of the beer bottle 10 to prevent the beer bottle 10 from escaping.

It should be noted that, in the description of the present invention, orientation or positional relationships indicated by the terms such as “front”, “back”, “left”, “right”, “up”, and “down” are based on the orientation or positional relationships shown in the accompanying drawings, and are to facilitate the description of the present invention and simplify the description only, rather than to indicate or imply that the device or element mentioned must have a specific orientation or be constructed and operated in a specific orientation, and therefore cannot be construed as limiting the present invention. Terms such as “mount”, “connect”, and “couple” should be interpreted in a broad sense, which, for example, can mean a fixed connection, a detachable connection or an integral connection; and can mean a direct connection, an indirect connection by means of an intermediary, or internal communication between two elements. For those of ordinary skill in the art, the specific meaning of the terms mentioned above in the present invention should be construed to specific circumstances.

1. A multi-lid heat-insulating cup, comprising a heat-insulating cup body (1) with an accommodating cavity (11) and a cup lid (2) detachably connected to the heat-insulating cup body (1), the cup lid (2) being provided with a drinking mouthpiece (221) and a drinking mouthpiece lid (3) being disposed at the drinking mouthpiece (221), wherein an inner top surface of the cup lid (2) is provided with a ring-shaped sealing gasket (5); and with the cup lid (2) covering an opening end of the heat-insulating cup body (1), the sealing gasket (5) is capable of sealing both the opening end of the heat-insulating cup body (1) and a top periphery of a pop can (4) placed in the accommodating cavity (11), and a beverage outlet of the pop can (4) is in communication with the drinking mouthpiece (221).

2. The multi-lid heat-insulating cup of claim 1, wherein an inner wall of the heat-insulating cup body (1) is provided with one or more step portions (12), such that a diameter of an upper section of the accommodating cavity (11) is greater than that of a lower section.

3. The multi-lid heat-insulating cup of claim 1, wherein the drinking mouthpiece (221) is configured to protrude upwards, the drinking mouthpiece lid (3) is attached to the drinking mouthpiece (221) by a threaded or snap-fit connection, and an inner end surface of the drinking mouthpiece lid (3) is provided with a sealing ring (6) which forms sealing with an opening end of the drinking mouthpiece (221).

4. The multi-lid heat-insulating cup of claim 3, wherein a connecting sheet (7) is hinged to a top portion of the cup lid (2), the connecting sheet (7) is provided with a mounting hole (71), and the drinking mouthpiece lid (3) is constrained within the mounting hole (71) and capable of rotating around its own axis.

5. The multi-lid heat-insulating cup of claim 1, wherein the cup lid (2) comprises an outer lid (21) and a top lid (22), the outer lid (21) being ring-shaped; the outer lid (21) is attached to the heat-insulating cup body (1) by a threaded or snap-fit connection; a top portion of an inner peripheral wall of the outer lid (21) is provided with an inwardly extending stop ring (211); the top lid (22) is detachably nested into the stop ring (211), a bottom surface of the top lid (22) has a downwardly extending ring-shaped wall (222), a nesting groove (23) in which the sealing gasket (5) is to be nested is formed between an outer periphery of the ring-shaped wall (222) and the inner peripheral wall of the outer lid (21), and the drinking mouthpiece is disposed on the top lid (22) and is in communication with a space defined by the ring-shaped wall (222).

6. The multi-lid heat-insulating cup of claim 6, wherein an outer periphery of the top lid (22) and an inner wall of the stop ring (211) are detachably attached to each other by a snap-fit connection through a rib-groove configuration (8).

7. The multi-lid heat-insulating cup of claim 6, wherein a bottom portion of the outer periphery of the ring-shaped wall (222) is provided with an outwardly extending stop (2221), and the stop (2221) forms a position limitation on a bottom surface of the sealing gasket (5).

8. The multi-lid heat-insulating cup of claim 6, wherein a top surface of the sealing gasket (5) is provided with a plurality of upwardly extending elastic catches (51), the top lid (22) is provided with recesses (223), and the elastic catches (51) are snap-fitted in the recesses (223).

9. The multi-lid heat-insulating cup of claim 6, wherein a top surface of the outer lid (21) is fixedly provided with a ring-shaped limiting member (9) made of a flexible material, and an inner edge (91) of the limiting member (9) protrudes radially inward from a peripheral wall of the stop ring (211).

10. The multi-lid heat-insulating cup of claim 9, wherein the limiting member (9) is integrally formed with the outer lid (21).
